(19) United States
(12) Patent Application Publication
(10) Pub. No.: US 2026/0176505 A1
(43) Pub. Date: Jun. 25, 2026

(54) ADHESIVE TAPE FOR BUNDLING MOTOR-VEHICLE CABLES

(71) Applicants: Timo LEERMANN, Wuppertal (DE); Rene RAMBUSCH, Wuppertal (DE); Lorand BONDA, Wuppertal (DE)

(72) Inventors: Timo LEERMANN, Wuppertal (DE); Rene RAMBUSCH, Wuppertal (DE); Lorand BONDA, Wuppertal (DE)

(21) Appl. No.: 19/411,212

(22) Filed: Dec. 6, 2025

(30) Foreign Application Priority Data
Dec. 23, 2024 (DE) 102024139703.9
Mar. 13, 2025 (DE) 202025101340.1

(51) Int. Cl. C09J 11/06; C09J 5/00; C09J 7/21; C09J 7/22; C09J 7/28; C09J 7/38; C09J 11/04

(52) U.S. Cl. CPC C09J 11/06; C09J 5/00; C09J 7/21; C09J 7/22; C09J 7/28; C09J 7/38; C09J 11/04; C09J 2203/302; C09J 2301/302; C09J 2301/408; C09J 2301/41; C09J 2400/163; C09J 2400/263

(57) ABSTRACT

An adhesive tape for wrapping cables in automobiles has a flame-resistant substrate band and a pressure-sensitive adhesive coating on at least one face of the band. The coating contains a halogen-free flame retardant based on a single organophosphorus compound with a melting point of more than 85 E_{C}. The substrate band is halogen-free and does not contain halogenated flame retardants.

### FIELD OF THE INVENTION

The present invention relates to an adhesive tape. More particularly this invention concerns such a tape specifically intended for wrapping cable bundles in a motor vehicle.

### BACKGROUND OF THE INVENTION

Suitable adhesive tapes for the above use are known from practice. When used for wrapping cables in automobiles, it is typically important that the adhesive tapes in question can be torn by hand to facilitate handling and installation. In addition, requirements regarding media resistance, for example to gasoline or oil, must be met. Furthermore, it is often important for such adhesive tapes to be abrasion-resistant in order to protect the cables of a cable harness wrapped with them from physical wear. In connection with handling, a certain tensile strength in the longitudinal direction is also required.

Suitable adhesive tapes as those described in DE 101 50 453 by applicant also use a flame retardant in or on the substrate band to achieve a flame-resistant finish, at least in the substrate band. This is often necessary in the applications described in order to reduce or completely suppress flammability.

In fact, especially in electric or hybrid vehicles, the batteries used there can cause so-called spontaneous combustion. In order to prevent possible sources of fire at this point or at least minimize their spread, flame retardants are used in the substrate band of the adhesive tape in question in the prior art. Such flame retardants can reduce the flammability of the substrate band through a number of mechanisms. For example, such flame retardants can be used to extinguish free radicals in the gas phase. In addition, flame retardants can react with chemical fragments of the burning material to initiate the formation of carbon and thus contain the fire. In addition, fire retardants are used to form barrier layers within the burning material.

In addition to the prior art referred to above, which already describes a flame-retardant substrate band in an adhesive tape in connection with its use for wrapping cables in automobiles, it is also known in principle to use flame retardants in conjunction with pressure-sensitive adhesive compositions, as described in detail in WO 2024/184 507 A1. However, this is not about wrapping cables in automobiles, but about laminating processes. For this purpose, a polyester film is typically used as a substrate band and provided with a pressure-sensitive adhesive composition for use in spray applications. Among other things, an organophosphorus flame retardant is used for the adhesive composition for this purpose.

The known polyester film with the detailed pressure-sensitive adhesive composition is used, for example, in the manufacture of battery packs and/or modules for electric vehicles or interior trim components for motor vehicles. In these motor vehicle interior areas, neither high temperatures nor sharp edges are typically observed. Furthermore, gasoline, oil, or other aggressive chemicals that could attack or damage the cable harness wrapped with adhesive tape are not present.

Finally, the prior-art publication DE 10 2007 027 852 A1 deals with a wrapping tape with a film made of thermoplastic polyurethane. The polyurethane is optionally provided with a phosphorus-containing flame retardant. In addition, the film or substrate band of the flame-retardant wrapping tape used at this point has an adhesive coating in the form of a pressure-sensitive adhesive coating.

With regard to the adhesive used here, various additives, plasticizers, and fillers are mentioned in addition to a flame retardant. However, it remains unclear which flame retardants are used in connection with the adhesive coating.

Accordingly, the object of the invention is to further develop such an adhesive tape for wrapping cables in automobiles in such a way that, taking into account its special suitability for the engine compartment and the conditions prevailing there, an effective flame-retardant finish is provided at the same time.

### OBJECTS OF THE INVENTION

It is therefore an object of the present invention to provide an improved adhesive tape for bundling motor-vehicle cables.

### SUMMARY OF THE INVENTION

An adhesive tape for wrapping cables in automobiles has according to the invention a flame-resistant substrate band and a pressure-sensitive adhesive coating on at least one face of the band. The coating contains a halogen-free flame retardant based on a single organophosphorus compound with a melting point of more than 85 E_{C}.

In fact, the invention proceeds in such a way that the adhesive tape is first provided with a preferably halogen-free and flame-retardant substrate band. This halogen-free and flame-retardant substrate band is one that does not contain halogenated flame retardants. Halogenated flame retardants such as polychlorinated biphenyls are generally known and are extremely effective in preventing the development of fires in combustible materials. However, many of these halogenated flame retardants are now considered hazardous substances and are therefore banned in some regions, such as the European Union.

### SPECIFIC DESCRIPTION OF THE INVENTION

According to the invention, a halogen-free yet flame-retardant substrate band can generally have a film substrate band. Film substrate bands such as those based on polyester film have proven to be particularly advantageous in this regard. In this case, a suitable flame retardant can be applied, for example, by immersion of the film. It is also conceivable to add the flame retardant to the extrudate or the granulate for the extrusion of the film.

In addition, the flame retardant can also be incorporated as a comonomer in the respective plastic for making the film. In fact, thermoplastics such as PP (polypropylene), PE (polyethylene), and in particular PET (polyethylene terephthalate) as a special polyester film or polyamide are primarily used here.

Of particular importance for the invention is the fact that the adhesive coating is provided with the halogen-free flame retardant based on the single organophosphorus compound. This means that, in contrast to the prior art according to WO 2024/184 507 A1, the invention does not use a first and a second organophosphorus compound. Rather, it has proven to be entirely sufficient for the adhesive coating to be provided with the single organophosphorus compound. This reduces the manufacturing effort and thus the costs.

In addition, the design is such that the single organophosphorus compound in question, and thus the flame retardant as a whole, has a melting point of more than 85 E_{C}. The maximum limit is generally observed to be a melting point of less than 200 E_{C}, preferably less than 150 E_{C}, and in particular 125 E_{C} and less.

In addition, it has proven effective when the film substrate band is a metal film substrate band or contains one. In this case, an aluminum foil substrate band, a copper foil substrate band, etc. is used as the foil substrate band for the adhesive tape used in accordance with the invention. In principle, other metals are also suitable for producing the metal foil, such as silver, platinum, tin, zinc, titanium, but also metal oxides such as tin oxides, zinc oxides, magnesium oxides, etc. Of course, combinations in the form of a laminate are also conceivable, for example, in such a way that such a metal foil substrate band is combined with a polyester foil substrate band in the form of a laminate.

For example, a polyester film can be vapor-deposited with aluminum to form a film substrate band that contains a metal film substrate band, namely the aluminum layer on the polyester film substrate band. In any case, it can be expected that the substrate band for the adhesive tape can be designed to be not only halogen-free but also flame-resistant without the addition of flame retardants. This is ensured by the metal foil substrate band as such or, in the example, by the metal coating in the laminate consisting of the polyester foil substrate band and the aluminum layer. In either case, it can be expected that such a design will minimize the risk of fire/flames, especially in the engine compartment of the motor vehicle.

Furthermore, the plastic material used, such as polyester or polyamide, is characterized by high aging resistance and media resistance to chemicals and operating materials such as oil, gasoline, antifreeze, etc. This also results in high abrasion resistance, which is particularly relevant in the engine compartment under consideration here.

When using a film substrate band made of thermoplastic, in particular PET, this film substrate band is halogen-free and flame-retardant. Specifically, this means that the substrate band, and in particular the film substrate band, complies with the VTM-0 standard for the classification of its fire behavior. The VTM-0 standard is defined in the UL 94 V regulation, which will be explained in more detail below. The VTM-0 standard is a standard for characterizing the fire protection behavior of very thin films. This includes plastic materials that are too thin to undergo the usual standards and tests for classifying the fire behavior of plastics. In most cases, these are films that normally do not have horizontal load-bearing capacity and are typically used in flexible printed circuit boards. Material thicknesses of less than 1 mm are typically observed.

In fact, the UL 94V criteria catalog (Underwriters Laboratories, “Tests for Flammability of Plastic Materials for Parts in Devices and Appliances,” of 1 Dec. 2021) is usually used for such thicker plastics. The VTM test is now performed as follows: The burning time of a test piece is measured in seconds after a first and second flame exposure. In addition, the total burning time in seconds is determined after ten flame exposures. Furthermore, the so-called burning and afterglow times in seconds after the second flame exposure are determined and examined to see whether burn dripping occurs. The sample is then burned down to the retaining clip.

The following values must be achieved for classification in protection class VTM-0 film:
Burn time after first and second flame exposure of less than 10 seconds;
Total burn time after ten flame exposures of less than 50 seconds;
Burn and afterglow times of less than 30 seconds; No burn dripping; and
No burning down to the retaining clip.

As an alternative to testing according to the VTM standard, the substrate and, in particular, film substrates can also be classified in terms of their fire behavior in such a way that they are rated as self-extinguishing SE within the meaning of FMVSS 302 (Sep. 24, 1998). This is a US safety standard that covers the burning behavior of interior materials in motor vehicles. The DIN standard DEN 75/200 (1980 September), which was developed from the above-cited American standard FMVSS 302, takes a similar approach. The test procedures are practically identical, with the DIN standard only describing the test setup and the performance of the burning test as well as the determination of the burning rate, whereas FMVSS 302 also specifies evaluation criteria. Overall, this refers to a test in which the flammability of a test piece is determined in a clamped frame. The sample is exposed to a defined flame 38 mm high for a duration of 15 seconds.

The characteristic SE (self-extinguishing) SE means that the flame goes out within a total measurement distance, resulting in a burning rate of Omm/min, taking into account a burning distance of Omm and a burning time of 16 minutes.

As soon as a substrate band or film substrate band meets the criteria explained above, it is characterized as flame-resistant within the scope of the present invention. This also applies the same if a textile substrate band made of plastic fibers or filaments or a metal film substrate band is used instead of a film substrate band.

In fact, according to a further advantageous design, the substrate band is a textile substrate band made of, for example, plastic fibers or filaments. In this context, the textile substrate band can be designed as a nonwoven, woven, or knitted fabric, etc. In this case, staple fibers made of polyester and/or polyamide can be used advantageously, for example in a nonwoven fabric. The use of filament yarns or filaments made of polyester and/or polyamide is also conceivable. Such textile substrate bands can be manufactured particularly easily and cost effectively for wrapping cable bundles in automobiles, especially in the engine compartment. This is true, for example, in light of the fact that adhesive tapes can be produced in this way that meet all the requirements of standard LV 312-1 (October 2009). In this way, the adhesive tape according to the invention can generally be designed to be tearable by hand, which typically corresponds to a breaking force in the transverse direction of the adhesive tape of less than 90 N/cm according to DIN EN 14410 (2003-06).

In addition, the intended use of the adhesive tape also requires a certain abrasion resistance, which, according to the above-cited standard LV 312-1, manifests itself in the fact that at least abrasion class C is achieved. This corresponds to an abrasion test described in the relevant standard, which corresponds to a minimum of 500 to 999 strokes until abrasion class C is reached. Furthermore, the adhesive tapes used in the invention are typically characterized in the described use by a stretch-to-break between the original sample length and the length at the moment of breaking of less than 200% and, in particular, less than 50%. In addition, the adhesive tape used or its substrate band generally has a basis weight that does not exceed 350 g/m².

Another important criterion to be taken into account in this context is that the adhesive tape generally exhibits a certain overall temperature resistance that in this case corresponds to temperature class C according to LV 312-1 and is associated with a continuous service temperature of 125 E_{C}. The lower limit for the continuous operating temperature in connection with temperature class C is −40 E_{C}.

In addition, the special chemical resistance of the substrate band or the adhesive tape as a whole is important because, in the claimed application, the cable sets wrapped with the adhesive tape may come into contact with aggressive liquids and must nevertheless remain resistant in order to ensure their long-term functionality. To this end, cables are wrapped with adhesive tape, bent into a U-shape, and immersed in the chemical to be tested, for example, lubricating grease. The test specimens are then stored in a heating cabinet for usually 1000 hours and subjected to a visual and tension test, as described in detail in above-cited standard LV 312-1. In particular, it is important to achieve a resistance of at least 240 hours for all chemicals that are relevant in this context and are listed in the LV 312-1 standard in question. By using polyester or polyamide in particular as the base materials for the substrate band, these requirements are typically met, whether as a film substrate band or as a textile substrate band.

In addition, the adhesive tape in question is subjected to a flame resistance test and at this point is observed to have at least fire class C according to LV 312-1 with burning speeds significantly below 100 mm/min, in most cases even less than 50 mm/min. In some cases, fire class B (self-extinguishing) or even A (non-combustible) can be achieved and implemented. The above-cited test is generally passed without any problems by the adhesive tapes in question, provided that the previously specified standards VTM-0 or SE in accordance with FMVSS 302 or DIN 75200 are met for the substrate band and, in addition, the adhesive coating is designed to meet the requirements.

For this purpose, the plastic fibers or filaments in the case of the textile substrate band are provided with an incorporated and preferably coextruded flame retardant. Something similar can also be done and implemented if the substrate band is a film substrate band. This means that the flame retardant is introduced into the extruder together with, for example, polymer granulate during production of the plastic fibers or filaments or the film substrate band and coextruded together with the polymer material in order to produce the plastic fibers or filaments or the film. This results in a particularly effective and homogeneous mixing with the polymer material for the plastic fibers or filaments or even the film substrate band.

The flame retardant added to the polymer material to produce the substrate band can be introduced in a grammage of approx. 0.5 wt % to approx. 20 wt % based on the total weight of the substrate band. The corresponding mixture of the flame retardant and the polymer material is usually produced before extrusion or the flame retardant is added to the extrudate in the specified grammage. This can be either an inorganic or an organic flame retardant, as will be explained in more detail below. A mixture is also conceivable.

The flame retardant can also be present as a comonomer in the plastic, whether it the plastic for making the film substrate band or the plastic for making plastic fibers or filaments in the textile substrate band. In this case, the flame retardant is incorporated into the plastic, as it were. Comparable grammages for the flame retardant are observed in comparison to the polymer material, as described above.

The flame retardant used for the substrate band in this case can generally be an inorganic one, for example based on metal oxides, metal hydroxides, and clays. In principle, a flame retardant for the substrate band based on, for example, a phosphate, in this case aluminum polyphosphate, is also conceivable. In addition, an organophosphorus compound can be considered as a flame retardant.

The adhesive coating, like the substrate, is also flame-retardant or flame-resistant. For this purpose, the adhesive coating contains a halogen-free flame retardant with a melting point of more than 85 E_{C}. In addition, it has proven to be particularly advantageous if the flame retardant for the adhesive coating from the pressure-sensitive adhesive has a melting point of less than 125 E_{C}. As a result, in the event of a fire, the flame retardant typically promotes the formation of carbon, which extinguishes any flames.

The flame retardant is generally present in the adhesive coating or in the pressure-sensitive adhesive in a weight percentage of approximately 0.5% to 30% based on the total weight of the adhesive. In addition, inorganic-based additives can be used for the flame retardant at this point. For example, the additive may be based on metal oxides, metal hydroxides, and clays. In this context, it is conceivable that the flame retardant for the adhesive coating contains only the single organophosphorus compound and the additive or additives in question.

The flame retardant for the adhesive coating based on the single organophosphorus compound is, for example, phosphanates or phosphinates. If both organic and inorganic flame retardants are used, the invention recommends that the inorganic flame retardant or additive be present in the mixture in an amount of up to 10% by weight, based on the total mass or total weight of the adhesive coating. The remaining up to 20% by weight is taken up by the organic flame retardant or the single organophosphorus compound.

Among others, phosphaphenanthrene, phosphonamidates, phosphazene, and in particular cyclotriphosphazene and phosphoric acid esters have proven to be particularly favorable as flame retardants. The adhesive itself may otherwise be acrylate-based and also contain an adhesive resin. Alternatively, an adhesive based on a styrene block copolymer is also conceivable and is covered by the invention.

Such organic flame retardants are characterized by the fact that they enable the adhesive coating and thus the adhesive tape to be designed to be flame retardant. This corresponds to the fact that, when exposed to a test flame, the adhesive tape does not burn for longer than 60 seconds after a total of five 15-second applications of the test flame in accordance with the UL 510 (2020 Apr. 17) standard. The standard in question is a regulation established in the USA, which was originally used for testing plastics in electrical appliances, but has now become established worldwide for classifying the flame resistance and fire safety of plastics. The adhesive tape is exposed to a test flame and must not burn for longer than 60 seconds after five 15-second applications. The term UL stands for Underwriters Laboratories. In most cases, the stricter standards SE referred to above in the sense of FMV SS 302 or DIN 75200 or VTM-0 are also fulfilled in this context.

A comparable approach is taken in LV 312-1, where a low burning speed of well below 100 mm/min is observed in accordance with the fire class C achieved for the adhesive tape used in the invention, and in most cases the material exposed to the flame (adhesive tape) extinguishes before the 15-second duration described above has been reached.

The result describes the use of an adhesive tape for wrapping cables in automobiles and, in particular, for wrapping cables in engine compartments of automobiles, which is characterized in that the adhesive tape is provided with both a regularly halogen-free and flame-resistant substrate band and an adhesive coating made of a pressure-sensitive adhesive and provided with a halogen-free flame retardant with a melting point of more than 85 E_{C} and usually less than 125 E_{C}. This typically achieves at least fire class C according to LV 312-1, or the adhesive tape is characterized by the fact that a test flame in accordance with the UL 510 (2020 Apr. 17) standard causes the adhesive tape to burn for less than 15 seconds.

This makes the adhesive tape used ideal for the applications described, because not only is it flame-resistant, but it also meets the other requirements necessary for the intended use. This applies in particular to its tear resistance and abrasion resistance. As a result, it can be expected that the adhesive tape will provide effective protection for the cable harness wrapped with it during normal operation and will be easy to handle. If a textile substrate band is used at this point, it can also be assumed that not only will the required chemical resistance and flame resistance be achieved, but also a noise-reducing effect will be observed. In this context, it has proven advantageous if the adhesive tape in question also exhibits at least medium noise reduction in accordance with class C according to LV 312-1. This reduces any rattling noises during operation to a minimum.

This is further enhanced by the fact that the adhesive tape in question is either wound helically around the cables or wrapped around the cables as a longitudinal cover. Such an application is possible and is included because the flame-resistant substrate band generally has a basis weight of between 50 g/m² and 300 g/m² and a material thickness of up to 5 mm. A basis weight of 80 g/m² to 200 g/m² is observed for the adhesive coating. The adhesive coating itself may have a layer thickness of up to 2 mm. In addition, the adhesive coating can be applied to the substrate band over the entire surface and continuously, in strips or even in dots. This is where the main advantages can be seen.

We claim:

1. An adhesive tape for wrapping cables in automobiles, the adhesive tape comprising:
a flame-resistant substrate band; and
a pressure-sensitive adhesive coating on at least one face of the band, the coating containing a halogen-free flame retardant based on a single organophosphorus compound with a melting point of more than 85 E_{C}.

2. The adhesive tape according to claim 1, wherein the flame retardant of the adhesive coating has a melting point of less than 200 E_{C}.

3. The adhesive tape according to claim 1, wherein the flame retardant in the adhesive coating is present in a weight percentage of 0.5% to 30% by weight, based on the total weight of the pressure-sensitive adhesive.

4. The adhesive tape according to claim 1, wherein the flame retardant of the adhesive coating also comprises a metal oxide, metal hydroxide or clay.

5. The adhesive tape according to claim 1, wherein the flame retardant of the adhesive coating is based on phosphanates, phosphinates, phosphaphenanthrenes, phosphonamidates, phosphazene and phosphoric acid esters.

6. The adhesive tape according to claim 1, wherein the substrate band is a film substrate band.

7. The adhesive tape according to claim 6, wherein the film substrate band is made from polypropylene, polyethylene, and/or polyethyene terephthalate.

8. The adhesive tape according to claim 6, wherein the substrate band complies with the VTM-0 standard for the classification of its fire behavior or is classified as self-extinguishing SE within the meaning of the FMVSS 302/DIN 75200 standard.

9. The adhesive tape according to claim 1, wherein the film substrate band is at least partially formed of a metal film.

10. The adhesive tape according to claim 1, wherein the substrate band is a textile substrate band made of plastic fibers or filaments.

11. The adhesive tape according to claim 10, wherein the plastic fibers or filaments are provided with an incorporated and preferably coextruded flame retardant.

12. The adhesive tape according to claim 10, wherein the flame retardant is anchored as.

13. The adhesive tape according to claim 10, wherein the flame retardant is a comonomer in the plastic fibers or filaments.

14. The adhesive tape according to claim 10, wherein the flame retardant for the substrate band is a phosphate and/or a metal oxide.

15. A method comprising the steps of:
providing an adhesive formed of a flame-resistant substrate band and a pressure-sensitive adhesive coating on at least one face of the band, the coating containing a halogen-free flame retardant based on a single organophosphorus compound with a melting point of more than 85 E_{C}; and
wrapping the tape around cables in a motor vehicle.

16. The method according to claim 15, wherein the adhesive tape is wound helically around the cables.

17. The method according to claim 15, wherein the tape extends longitudinally along the cables.
